(19) United States
(12) Patent Application Publication
(10) Pub. No.: US 2008/0087631 A1
(43) Pub. Date: Apr. 17, 2008

(54) Ion gun, ion beam etching apparatus, ion beam etching facility, etching method, and method for manufacturing magnetic recording medium

(75) Inventors: Kazuhiro Hattori, Tokyo (JP); Kazuya Shimakawa, Tokyo (JP); Mitsuru Takai, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 11/907,269

(22) Filed: Oct. 10, 2007

(30) Foreign Application Priority Data
Oct. 12, 2006 (JP) 2006-278755
Aug. 29, 2007 (JP) 2007-223111

(51) Int. Cl. H01J 27/02; B44C 1/22

(52) U.S. Cl. 216/22; 216/66; 250/423 R

(57) ABSTRACT

A compact ion gun capable of flattening both sides of a substrate, an ion beam etching apparatus provided with the ion gun, an ion beam etching facility, an etching method using them, and a method for manufacturing a magnetic recording medium are provided. The ion gun includes a plasma generation source and an extraction electrode unit. The extraction electrode unit has: a first electrode unit including a portion of a plurality of electrode plates on a first side of a reference plane intersecting the electrode plates, the portion being inclined with respect to the reference plane so as to face an irradiation target area along the reference plane; and a second electrode unit including a portion of the electrode plates on a second side of the reference plane, the portion being inclined with respect to the reference plane so as to face the irradiation target area along the reference plane.

### BACKGROUND OF THE INVENTION

1. Field of the Invention

The present invention relates to an ion gun, an ion beam etching apparatus provided with the ion gun, an ion beam etching facility, an etching method using them, and a method for manufacturing a magnetic recording medium.

2. Description of the Related Art

A significant improvement in the areal density of magnetic recording media such as hard disks has been achieved by, for example, reducing the size of magnetic particles constituting a recording layer, changing materials, and improving the precision of head processing. A further improvement in the areal density is expected in the future.

However, problems such as recording of data on an incorrect track adjacent to a target track and crosstalk during reproduction, which are caused by the limit of head processing and magnetic field broadening, have become apparent. Hence, the improvement of the areal density by conventional improvement techniques has reached its limit.

In view of this, discrete track media and patterned media, in which a recording layer is divided into a large number of recording elements, have been proposed as candidates for magnetic recording media which may be capable of achieving a further improvement in the areal density (see, for example, Japanese Patent Application Laid-Open No. Hei 09-97419).

When the surface roughness of a recording medium is large, the flying characteristics of the magnetic head are unsatisfactory. Therefore, it has been proposed to flatten the surface of the recording medium by depositing a filling material onto a recording layer that has been formed into a concavo-convex pattern of the recording medium in order to fill in the concave portions thereof and by then removing the excess filling material deposited above the convex portions.

It has been proposed to use a method called ion milling or ion beam etching as a surface flattening method (see, for example, Japanese Patent Application Laid-Open No. 2005-235356). In such a method, the surface of a substrate is irradiated with a processing gas such as Ar from a direction that is inclined with respect to the surface. In order to flatten the surface to a desired level, it is supposed that the surface of the substrate should be irradiated with the processing gas at a low irradiation angle of, for example, approximately 30° or less.

As described in, for example, Japanese Patent Application Laid-Open Nos. Sho 62-113345, 2000-273630, and 2006-100205 and Japanese Translation of PCT International Application No. 2002-510428, an ion beam etching apparatus comprises an ion gun having a plasma generation source and an extraction electrode unit and, when in use, the apparatus is positioned such that the extraction electrode unit of the ion gun faces one surface of a thin plate-like workpiece. In order to irradiate the surface of the workpiece with a processing gas from a direction that is inclined with respect to the surface, the ion gun is positioned such that the extraction electrode unit faces one surface of the workpiece at a certain inclined angle.

In general, a magnetic recording medium has a recording layer on both sides of its substrate. Hence, in order to improve manufacturing productivity, it is preferable to flatten both sides of the magnetic recording medium simultaneously (see, for example, Japanese Patent Application Laid-Open No. 2005-56535). Furthermore, in terms of suppressing any warpage of the substrate due to processing, it is also preferable to flatten both sides of the magnetic recording medium simultaneously.

However, in order to flatten both sides of the magnetic recording medium simultaneously, two ion guns must be provided in an ion beam etching apparatus, and therefore a problem arises in that the size of the apparatus increases.

More specifically, the volume of a plasma generation source for an ion gun is large. Therefore, when two ion guns are positioned such that the plasma generation sources thereof do not interfere with each other, large portions of the two ion guns protrude at opposing angles from the vacuum chamber, and therefore the size of the apparatus is increased.

In addition, in order to improve manufacturing productivity, it is preferable to process a plurality of substrates simultaneously. However, in this case, the irradiation target area for ion irradiation becomes large. Therefore, large-size ion guns with an extraction electrode unit having a large area must be provided, and the distances between the substrates and the ion guns must be large. Hence, the size of the ion beam etching apparatus is further increased.

Moreover, since the plasma generated in the plasma generation source is unstable, a problem arises in that it is difficult to irradiate both sides of an irradiation object with ion beams having the same intensity from two ion guns.

### SUMMARY OF THE INVENTION

In view of the foregoing problems, various exemplary embodiments of this invention provide a compact ion gun capable of etching both sides of a substrate, an ion beam etching apparatus provided with the ion gun, an ion beam etching facility, an etching method using them, and a method for manufacturing a magnetic recording medium.

In the various exemplary embodiments of the present invention, the above object is achieved by an ion gun comprising: a plasma generation source; and an extraction electrode unit comprising a plurality of electrode plates each having a plurality of through holes formed therein to allow ions from the plasma generation source to pass therethrough, wherein the extraction electrode unit comprises: a first electrode unit including a portion of the plurality of electrode plates on a first side of a predetermined reference plane intersecting the electrode plates, with the portion being inclined with respect to the reference plane so as to face a predetermined irradiation target area which is provided along the reference plane on a farther side away from the plasma generation source than the extraction electrode unit; and a second electrode unit including apportion of the plurality of electrode plates on a second side of the reference plane, with the portion being inclined with respect to the reference plane so as to face the irradiation target area.

Moreover, in the various exemplary embodiments of the present invention, the above object is achieved by an ion gun comprising: a plasma generation source; and an extraction electrode unit comprising a plurality of electrode plates each having a plurality of through holes formed therein to allow ions from the plasma generation source to pass therethrough, wherein the extraction electrode unit comprises: a first electrode unit including a portion of the plurality of electrode plates on a first side of a predetermined reference plane intersecting the electrode plates, the first electrode unit being provided for irradiating, from the first side, a predetermined irradiation target area with ions from the plasma generation source in an irradiation direction inclined with respect to the reference plane, the irradiation target area being provided along the reference plane at a farther side away from the plasma generation source than the extraction electrode unit; and a second electrode unit including a portion of the plurality of electrode plates on a second side of the reference plane, the second electrode unit being provided for irradiating, from the second side, the irradiation target area with ions from the plasma generation source in an irradiation direction inclined with respect to the reference plane.

These ion guns can respectively irradiate both sides of a workpiece placed in the irradiation target area with ions. Hence, both sides of the workpiece can be flattened simultaneously using only one ion gun. Therefore, it is sufficient that an ion beam etching apparatus be provided with only one such ion gun, and this contributes to making the ion beam etching apparatus compact.

Furthermore, in the above-detailed ion guns, common components can be used in a part of, or in all of the components of the plasma generation source for supplying ions to the first and second electrode units, and this also contributes to make the ion beam etching apparatus compact.

Moreover, each of the above-detailed ion guns can supply ions from the common plasma generation source to the first and second electrode units. Hence, both sides of a workpiece can be easily irradiated with ion beams having the same intensity. Therefore, both sides of the workpiece can be etched to the same extent, and the effect of suppressing any warpage of the thin plate-like workpiece is significant.

Accordingly, various exemplary embodiments of this invention provide an ion gun comprising: a plasma generation source; and an extraction electrode unit comprising a plurality of electrode plates each having a plurality of through holes formed therein to allow ions from the plasma generation source to pass therethrough, wherein the extraction electrode unit comprises: a first electrode unit including a portion of the plurality of electrode plates on a first side of a predetermined reference plane intersecting the electrode plates, with the portion being inclined with respect to the reference plane so as to face a predetermined irradiation target area which is provided along the reference plane on a farther side away from the plasma generation source than the extraction electrode unit; and a second electrode unit including a portion of the plurality of electrode plates on a second side of the reference plane, with the portion being inclined with respect to the reference plane so as to face the irradiation target area.

Moreover, various exemplary embodiments of this invention provide an ion gun comprising: a plasma generation source; and an extraction electrode unit comprising a plurality of electrode plates each having a plurality of through holes formed therein to allow ions from the plasma generation source to pass therethrough, wherein the extraction electrode unit comprises: a first electrode unit including a portion of the plurality of electrode plates on a first side of a predetermined reference plane intersecting the electrode plates, the first electrode unit being provided for irradiating, from the first side, a predetermined irradiation target area with ions from the plasma generation source in an irradiation direction inclined with respect to the reference plane, the irradiation target area being provided along the reference plane on a farther side away from the plasma generation source than the extraction electrode unit; and a second electrode unit including a portion of the plurality of electrode plates on a second side of the reference plane, the second electrode unit being provided for irradiating, from the second side, the irradiation target area with ions from the plasma generation source in an irradiation direction inclined with respect to the reference plane.

Furthermore, various exemplary embodiments of this invention provide an ion beam etching apparatus, comprising any one of the ion guns.

Moreover, various exemplary embodiments of this invention provide an ion beam etching facility, comprising: a perpendicular irradiation ion beam etching apparatus comprising a perpendicular irradiation ion gun capable of irradiating a surface of a plate-like workpiece with ions in a direction substantially perpendicular to the surface of the workpiece; and an inclined irradiation ion beam etching apparatus comprising any one of the ion guns.

Various exemplary embodiments of this invention provide an etching method, comprising: a workpiece placing step of placing a plate-like workpiece in the irradiation target area of any one of the ion guns so as to be parallel to the reference plane; and an etching step of etching opposite surfaces of the workpiece by irradiating a surface of the workpiece with ions from the first electrode unit and irradiating another surface of the workpiece with ions from the second electrode unit.

Moreover, various exemplary embodiments of this invention provide an method for manufacturing a magnetic recording medium, comprising a step in which the etching method is used.

Furthermore, various exemplary embodiments of this invention provide a method for manufacturing a magnetic recording medium, comprising: a perpendicular etching step of irradiating opposite surfaces of the workpiece with ions in respective directions substantially perpendicular to the respective opposite surfaces of the workpiece by means of the perpendicular irradiation ion beam etching apparatus and inclined etching step of irradiating the opposite surfaces of the workpiece in respective directions inclined with respective to the respective opposite surfaces of the workpiece by means of the inclined irradiation ion beam etching apparatus, wherein the perpendicular etching step and the inclined etching step are carried out in this order.

In the present application, the term “ion beam etching” is used to refer to a generic name for processing methods, such as ion milling, for removing the surface of a workpiece by uniformly irradiating the workpiece with ionized gas.

According to various exemplary embodiments of the present invention, there can be realized a compact ion gun capable of irradiating both sides of a workpiece with ions, an ion beam etching apparatus provided with the ion gun, an ion beam etching facility, an etching method using them, and a method for manufacturing a magnetic recording medium.

### BRIEF DESCRIPTION OF THE DRAWINGS

FIG. 1 is a cross-sectional side view schematically illustrating a structure of a main part of an ion gun according to a first exemplary embodiment of the present invention;

FIG. 2 is a bottom view of the ion gun;

FIG. 3 is an enlarged cross-sectional side view illustrating an extraction electrode unit in FIG. 1;

FIG. 4 is a cross-sectional side view schematically illustrating a structure of a main part of an ion beam etching apparatus provided with the ion gun;

FIG. 5 is a side view schematically illustrating a structure of an irradiation object in the first exemplary embodiment;

FIG. 6 is an enlarged side view illustrating a holding unit in FIG. 5;

FIG. 7 is a cross-sectional side view schematically illustrating a structure of a workpiece to be held by the holding unit;

FIG. 8 is a flowchart showing an outline of a method for manufacturing a magnetic recording medium by means of the ion beam etching apparatus provided with the ion gun;

FIG. 9 is a cross-sectional side view schematically illustrating a structure of a main part of an ion gun according to a second exemplary embodiment of the present invention;

FIG. 10 is a bottom view schematically illustrating a structure of an extraction electrode unit of an ion gun according to a third exemplary embodiment of the present invention;

FIG. 11 is a cross-sectional side view illustrating an extraction electrode unit of an ion gun according to a fourth exemplary embodiment of the present invention;

FIG. 12 is a cross-sectional side view illustrating an extraction electrode unit of an ion gun according to a fifth exemplary embodiment of the present invention;

FIG. 13 is a cross-sectional side view schematically illustrating a structure of an ion gun according to a sixth exemplary embodiment of the present invention;

FIG. 14 is a bottom view schematically illustrating a structure of a main part of an ion gun according to a seventh exemplary embodiment of the present invention;

FIG. 15 is a cross-sectional side view taken along the line XV-XV in FIG. 14;

FIG. 16 is a cross-sectional side view taken along the line XVI-XVI in FIG. 14;

FIG. 17 is a cross-sectional side view schematically illustrating a structure of a main part of an ion beam etching facility according to an eighth exemplary embodiment of the present invention; and

FIG. 18 is a flowchart showing an outline of a method for manufacturing a magnetic recording medium by means of the ion beam etching facility.

### DETAILED DESCRIPTION OF THE PREFERRED EMBODIMENTS

Hereinafter, preferred exemplary embodiments of the present invention are described in detail with reference to the drawings.

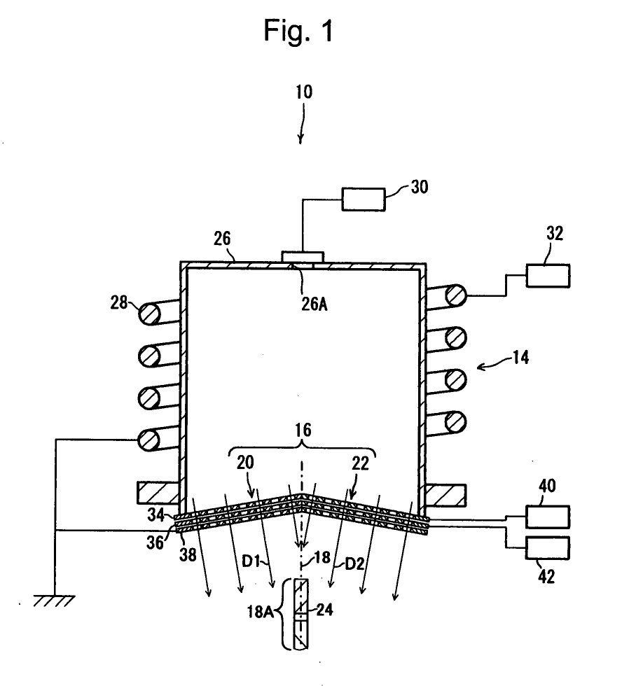

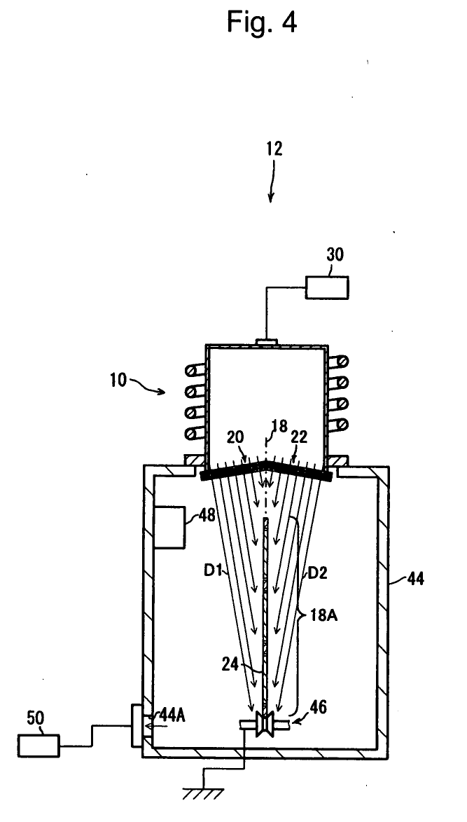

A first exemplary embodiment of the present invention relates to an ion gun 10 shown in FIGS. 1 to 3 and to an ion beam etching apparatus 12 provided with the ion gun 10 shown in FIG. 4.

The ion gun 10 comprises a plasma generation source 14 and an extraction electrode unit 16. The extraction electrode unit 16 has a first electrode unit 20 and a second electrode unit 22. In the first exemplary embodiment, the ion gun 10 is disposed in an upper portion of the ion beam etching apparatus 12 and is configured so as to emit ions in a downward direction.

The plasma generation source 14 has a discharge chamber 26 opening downwardly and a coil 28 disposed so as to surround the discharge chamber 26. The discharge chamber 26 and the coil 28 are common components of the plasma generation source 14 for supplying ions to both the first and second electrode units 20 and 22. An air supply hole 26A is formed in the upper portion of the discharge chamber 26. A gas supply apparatus 30 is provided for supplying a processing gas, such as Ar, Xe, or Kr, for generating plasma and is connected to the air supply hole 26A via a pipe. Furthermore, one end of the coil 28 is grounded, and the other end is connected to a high frequency power supply apparatus 32 (frequency: from several MHz to several tens of MHz, for example, 13.56 MHz).

The extraction electrode unit 16 comprises a plurality (three in the first exemplary embodiment) of thin plate-like electrode plates 34, 36, and 38 which are disposed close to one another. Each of the electrode plates 34, 36, and 38 has a corresponding plurality is of through holes 34A, 36A, and 38A formed therein to allow ions from the plasma generation source 14 to pass therethrough. The electrode plates 34, 36, and 38 are disposed in the lower portion of the discharge chamber 26 so as to be away from the plasma generation source 14 in that order. In the first exemplary embodiment, the extraction electrode unit 16 has a substantially circular shape when viewed from below. Moreover, the side wall of the discharge chamber 26 has a substantially cylindrical shape.

The first electrode unit 20 includes a portion of the electrode plates 34, 36, and 38 on a first side (being the left side in FIGS. 1 to 4) of a reference plane 18 which intersects the electrode plates 34, 36, and 38. Each of the portion on the first side is inclined with respect to the reference plane 18 so as to face an irradiation target area 18A which is provided along the reference plane 18 on a farther side away from the plasma generation source 14 than the extraction electrode unit 16. The second electrode unit 22 includes the other portion of the electrode plates 34, 36, and 38 on a second side (being the right side in FIGS. 1 to 4) of the reference plane 18. Each of the portion on the second side is inclined with respect to the reference plane 18 so as to face the irradiation target area 18A.

The first electrode unit 20 is configured such that the irradiation target area 18A is irradiated with ions from the plasma generation source 14 in a first irradiation direction D1 which is inclined with respect to the reference plane 18 from the first side (being the left side in FIGS. 1 to 4). The second electrode unit 22 is configured such that the irradiation target area 18A is irradiated with ions from the plasma generation source 14 in a second irradiation direction D2 which is inclined with respect to the reference plane 18 from the second side (being the right side in FIGS. 1 to 4).

The first and second electrode units 20 and 22 are arranged so as to be plane symmetrical one another with respect to the reference plane 18.

The irradiation angle formed by the reference plane 18 and each of the first and second irradiation directions D1 and D2 is set to a small angle, preferably within the range of 1° to 30°, and more preferably within the range of 1° to 5°. As used herein, the term “irradiation angle” is used to refer to an acute angle formed by the reference plane 18 and each of the first and second irradiation directions D1 and D2. Each of the first and second irradiation directions D1 and D2 is a direction of the central axis of the ion beam emitted from a corresponding one of the first and second electrode units 20 and 22. In reality, the respective traveling directions of ions emitted from the first and second electrode units 20 and 22 deviate to a certain extent from the first and second irradiation directions D1 and D2, respectively.

The electrode plate 34 is a screen grid which can isolate the plasma in the discharge chamber 26 from the electrode plate 36 and is connected to a positive electrode of a direct current power source 40. The electrode plate 36 is an acceleration grid and is connected to a negative electrode of a direct current power source 42. The electrode plate 38 is a deceleration grid, also known as an earth electrode, and is grounded. C (carbon) or Mo can be used as the material forming the electrode plates 34, 36, and 38.

Each of these electrode plates 34, 36, and 38 is bent along a portion where the reference plane 18 intersects so as to be plane symmetrical with respect to the reference plane 18, so that the portion where the reference plane 18 intersects protrudes toward the plasma generation source 14 side. In addition to this, the portion included in the first electrode unit 20 and the portion included in the second electrode unit 22 are integrally formed. In each of the electrode plates 34, 36, and 38, the portion included in the first electrode unit 20 is disposed perpendicular to the first irradiation direction D1, and the portion included in the second electrode unit 22 is disposed perpendicular to the second irradiation direction D2.

In the portions included in the first electrode unit 20, the through holes 34A, 36A, and 38A are arranged such that the through holes in each electrode plate are aligned with the corresponding through holes in the other electrode plates in the first irradiation direction D1. Further to this, in the portions included in the second electrode unit 22, the through holes 34A, 36A, and 38A are arranged such that the through holes in each electrode plate are aligned with the corresponding through holes in the other electrode plates in the second irradiation direction D2.

The ion beam etching apparatus 12 is further provided with: a vacuum chamber 44; a supporting portion 46; and a neutralizer 48. The supporting portion 46 can support a thin plate-like irradiation object 24 in the irradiation target area 18A within the vacuum chamber 44 such that the irradiation object 24 is parallel to the reference plane 18.

The vacuum chamber 44 has a substantially box-like shape, and has an attachment portion with opening for the ion gun 10 at the upper portion thereof. An exhaust hole 44A is provided in the lower portion of the vacuum chamber 44, and a vacuum pump 50 is connected to the exhaust hole 44A via a pipe.

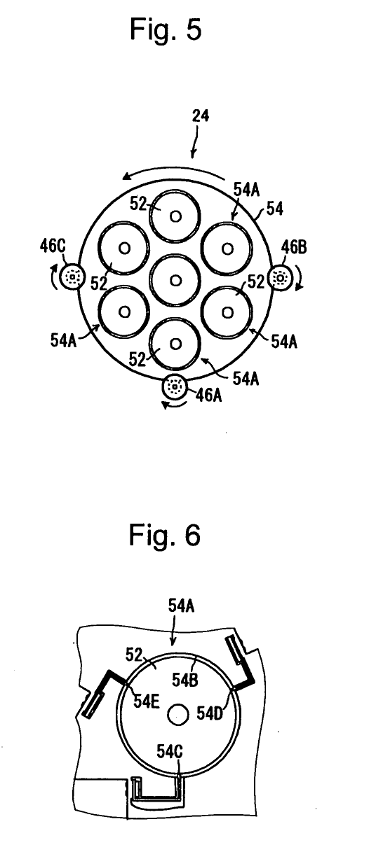

As shown in FIGS. 5 and 6, the irradiation object 24 has a holding unit 54 and a plurality of workpieces 52 held by the holding unit 54. Specifically, the workpieces 52 are intermediate products in a process for manufacturing magnetic recording media such as discrete track media or patterned media.

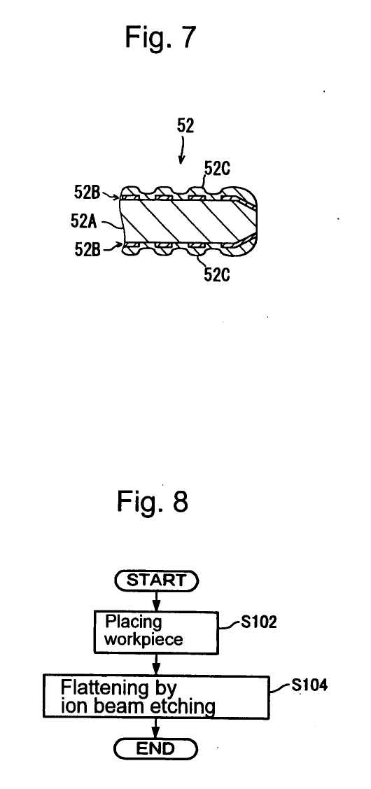

As shown in FIG. 7, each of the workpieces 52 includes: recording layers 52B formed into a concavo-convex pattern on the opposite sides of a disk-shaped substrate 52A; and a filling material 52C deposited on the recording layers 52B, where the concave portions in the recording layers 52B are filled with the filling material 52C. In reality, other layers such as an underlayer, an antiferromagnetic layer, a soft magnetic layer, and a seed layer are provided between the substrate 52A and the recording layers 52B. However, the description of these layers is omitted as it is not essential in order to understand the first exemplary embodiment of the present invention.

In the present application, the term “magnetic recording media” is not limited to media, such as hard disks, floppy ® disks, and magnetic tapes, in which magnetism alone is used for recording and reproducing information. The term is also used to refer to magneto-optical recording media, such as MO disks, in which both magnetism and light are used and to heat assisted type recording media in which both magnetism and heat are used.

The holding unit 54 is provided with a plurality of holding portions 54A for holding the plurality of substantially disk-shaped workpieces 52. Each of the holding portions 54A is configured such that one disk-shaped workpiece 52 is contained in a through hole 54B which is a size that is slightly larger than the workpiece 52. Three engagement members 54C, 54D, and 54E for engaging the disk-shaped workpiece 52 at three points on the periphery of the workpiece 52 are provided in the surroundings of each through hole 54B.

The supporting portion 46 is provided with three rollers 46A, 46B, and 46C and is configured such that the periphery of the generally disk-shaped irradiation object 24 is supported by the rollers 46A, 46B, and 46C with the irradiation object 24 held upright.

More specifically, a circumferential groove for engaging the outer periphery of the irradiation object 24 is formed in the outer periphery of each of these rollers 46A, 46B, and 46C. Further to this, these rollers 46A, 46B, and 46C are placed so as to support the disk-shaped irradiation object 24 near its lower end and near its horizontal opposite ends.

Moreover, some or all of the rollers 46A, 46B, and 46C are connected to a driving device (not shown) and are configured so as to rotate the substantially disk-shaped irradiation object 24.

The neutralizer 48 is configured to emit particles for neutralizing ions emitted from the ion gun 10. For example, the neutralizer 48 emits electrons into the vacuum chamber 44 for neutralizing positive ions, such as Ar⁺, emitted from the ion gun 10.

Next, the action of the ion gun 10 and the action of the ion beam etching apparatus 12 are described with reference to the flowchart shown in FIG. 8 by taking, as an example, a method for manufacturing a magnetic recording medium that includes a step of flattening both sides of the workpieces 52 by etching both of sides of the workpieces 52.

First, the irradiation object 24 is placed so as to be supported in an upright position by the supporting portion 46 of the ion beam etching apparatus 12. Thus, a plurality of the workpieces 52 held by the irradiation object 24 are placed in the irradiation target area 18A so as to be parallel to the reference plane 18 (S102).

Next, while the irradiation object 24 are rotated with the supporting portion 46, the opposite surfaces of the plurality of the workpieces 52 held by the irradiation object 24 are irradiated with ions from the ion gun 10 (S104). Specifically, the opposite surfaces of the workpieces 52 are irradiated with ions in plane symmetrical arrangement in the first and second irradiation directions D1 and D2 which are inclined with respect to the surfaces of the workpieces 52.

The filling material 52C on the opposite surfaces of the workpieces 52 is gradually removed as the ions impinge on the surfaces of the workpieces 52. When the upper surface of the convex portions of the recording layers 52B is exposed, the ion irradiation is terminated. In this manner, the surfaces of the workpieces 52 are flattened. In dry etching such as ion beam etching, convex portions tend to be selectively removed faster than concave portions. Further to this, by irradiating the surfaces of the workpieces 52 with ions from a direction which is inclined with respect to each of the surfaces, the tendency of convex portions to be selectively removed faster than concave portions is further enhanced. Therefore, high precision flattening can be performed. In order to achieve high precision flattening, the irradiation angle formed by the reference plane 18 and each of the first and second irradiation directions D1 and D2 should preferably fall within the range of 1° to 30°, and more preferably within the range of 1° to 5° (for example, about 2°).

After the flattening step (S104), a protection layer and a lubrication layer are formed on both sides of the workpieces 52 in accordance with need, whereby the magnetic recording media are completed.

As described above, since the ion gun 10 can irradiate both sides of the workpieces 52 with ions simultaneously, both the sides of the workpieces 52 can be flattened simultaneously using only one ion gun. Therefore, it is sufficient to provide only one ion gun 10 in the ion beam etching apparatus 12, and as such, the ion beam etching apparatus 12 is compact.

Moreover, the plasma generation source 14 of the ion gun 10 has common components for supplying ions to both the first and second electrode units 20 and 22. This also contributes to making the ion beam etching apparatus 12 compact.

Furthermore, in the ion gun 10, the plasma generation source 14 for supplying ions to the first and second electrode units 20 and 22 is common to both the first and second electrode units 20 and 22, and the space inside the discharge chamber 26 is also common to both of them. Hence, both sides of the workpieces 52 are easily irradiated with ion beams of the same intensity. Therefore, both sides of the workpieces 52 can be flattened to the same extent, and the effect of suppressing any warpage of the thin plate-like workpieces 52 is significant.

Next, a description of the second exemplary embodiment of the present invention will be given.

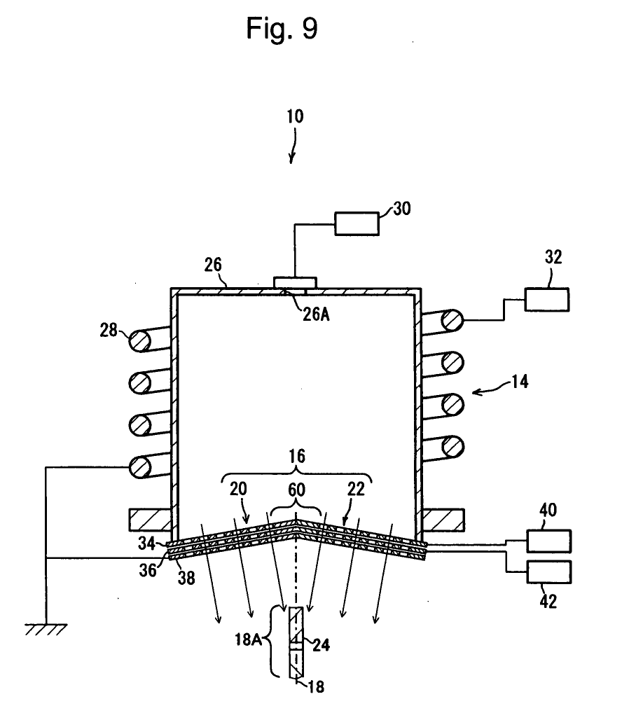

In contrast to the first exemplary embodiment, the second exemplary embodiment is characterized in that a non-irradiating portion 60 is provided between the first and second electrode units 20 and 22, as shown in FIG. 9. The non-irradiating portion 60 is provided for preventing the edge portion on the extraction electrode unit 16 side of the irradiation target area 18A from being irradiated with ions. Since the configuration of the other components is the same as that of the first exemplary embodiment, the same numerals as those employed in FIG. 1 and the like are employed for the same components, and a description thereof is omitted accordingly.

The non-irradiating portion 60 includes: a portion which is located at the central portion of each of the electrode plates 34, 36, and 38 (being a portion which the reference plane 18 intersects); and a portion near the central portion in which through holes are not formed.

As described above, by providing the non-irradiating portion 60, the outer peripheral surface of the irradiation object 24 can be prevented from being etched.

Next, a description of the third exemplary embodiment of the present invention will be given.

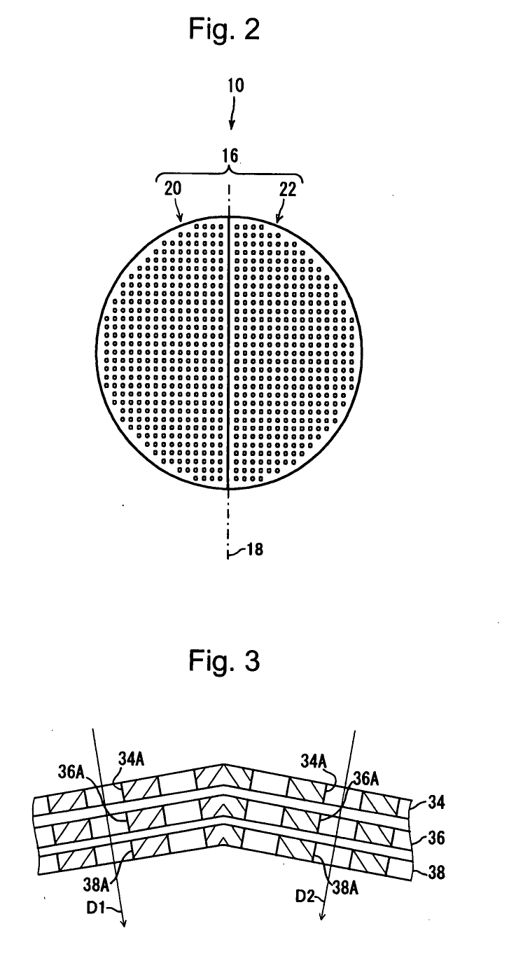

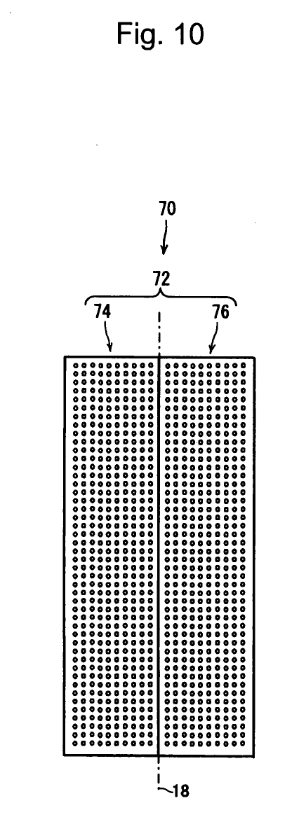

In contrast to the ion gun 10 of the first exemplary embodiment, an ion gun 70 of the third exemplary embodiment is characterized in that an extraction electrode unit 72 has a generally rectangular shape when viewed from below, as shown in FIG. 10. Specifically, the edges that are substantially parallel to the reference plane 18 are long, and the edges that are substantially perpendicular to the reference plane 18 are short. Both a first electrode unit 74 and a second electrode unit 76 have a substantially rectangular shape when viewed from below. In addition to this, the side wall of the discharge chamber has a generally rectangular prism-like shape (not shown). Since the configuration of the other components is the same as that of the first exemplary embodiment, the same numerals as those employed in FIG. 2 and the like are employed for the same components, and a description thereof is omitted accordingly.

Ions having passed through the electrode plate-through holes that are distant from the reference plane 18 may reach beyond the irradiation object and may therefore not be projected onto the irradiation object. This will be determined by the size of the irradiation object. When the irradiation angle formed by the reference plane 18 and each of the first and second irradiation directions D1 and D2 is small, the amount of ions not projected onto the irradiation object may increase. However, by forming the extraction electrode unit 72 into a substantially rectangular shape, when viewed from below, in which the edges that are substantially parallel to the reference plane 18 are long and the edges that are substantially perpendicular to the reference plane 18 are short, the amount of ions not projected onto the irradiation object can be reduced. In this manner, the irradiation efficiency of the irradiation object with the ion beam can be improved.

Next, a description of the fourth exemplary embodiment of the present invention will be given.

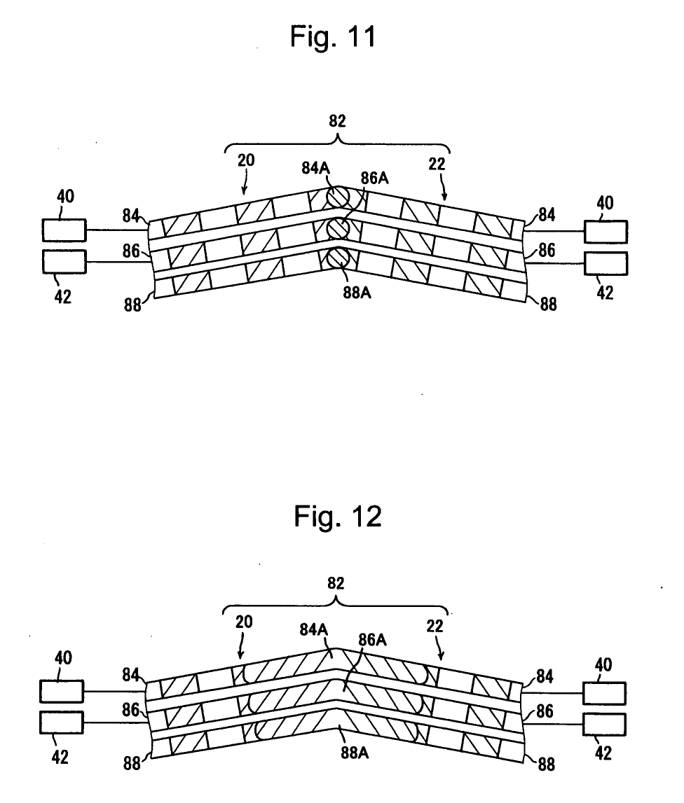

In contrast to the first exemplary embodiment, in the configuration of the fourth exemplary embodiment, electrode plates 84, 86, and 88 constitute an extraction electrode unit 82 that includes the first and second electrode units 20 and 22. In addition to this, insulating portions 84A, 86A, and 88A are provided between portions included in the first electrode unit 20 and portions included in the second electrode unit 22, as shown in FIG. 11. Since the configuration of the other components is the same as that of the first exemplary embodiment, a description thereof is omitted accordingly.

The material for the insulating portions 84A, 86A, and 88A, may include, for example, a ceramic containing Al, Ti, or C as the principal ingredient such as silicon carbide, titanium oxide, or AlTiC.

Moreover, two direct current power sources 40 are provided and are connected to the corresponding portions included in the first and second electrode units 20 and 22, respectively, in the electrode plate 84 serving as a screen grid.

Similarly, two direct current power sources 42 are provided and are connected to the corresponding portions included in the first and second electrode units 20 and 22, respectively, in the electrode plate 86 which serves as an acceleration grid.

As described above, by electrically insulating the portions included in the first and second electrode units 20 and 22, respectively, in each of the electrode plates 84, 86, and 88 constituting the extraction electrode unit 82, the voltages applied thereto can be adjusted independently. Hence, the intensity and energy of the ion beam emitted from the first electrode unit 20 and the intensity and energy of the ion beam emitted from the second electrode unit 22 can also be controlled independently. In this manner, for example, the intensity and energy of the ion beam projected onto one side of the irradiation object 24 and the intensity and energy of the ion beam projected onto the other side can be made coincident with each other with high precision. Alternatively, the intensity and energy of the ion beam projected onto one side of the irradiation object 24 can be intentionally made different from the intensity and energy of the ion beam projected onto the other side of the irradiation object 24.

Next, a description of the fifth exemplary embodiment of the present invention will be given.

In contrast to the fourth exemplary embodiment, in the configuration of the fifth exemplary embodiment, each of the insulating portions 84A, 86A, and 88A also serves as the non-irradiating portion in the second exemplary embodiment, as shown in FIG. 12. Since the configuration of the other components is the same as that of the second and fourth exemplary embodiments, a description thereof is omitted accordingly. The effects of the fifth exemplary embodiment are the same as those of the second and fourth exemplary embodiments, and a description thereof is also omitted accordingly. In the fourth and fifth exemplary embodiments, the insulating portion is provided between the portion included in the first electrode unit and the portion included in the second electrode unit in each of the electrode plates, and the reference plane intersects each insulating portion. However, in the present application, the expression “the reference plane intersecting the electrode plates” is also used for this case. Alternatively, the portion included in the first electrode unit and the portion included in the second electrode unit in each of the electrode plates may be provided so as to be separated from each other, and the reference plane may intersect a portion or space located between the separated portions. In the present application, the expression “the reference plane intersecting the electrode plates” is also used for this case.

Next, a description of the sixth exemplary embodiment of the present invention will be given.

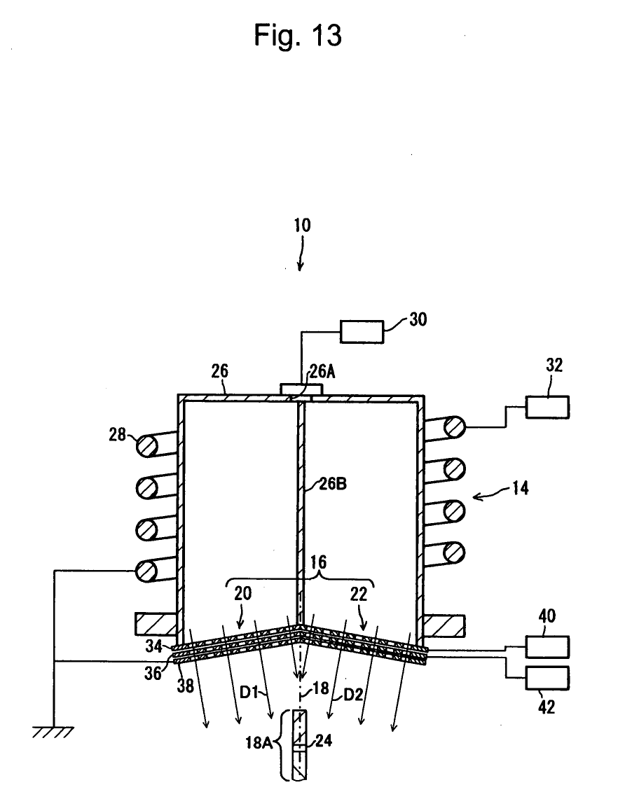

In contrast to the first exemplary embodiment, in the configuration of the sixth exemplary embodiment, a partition wall 26B is provided in the discharge chamber 26, as shown in FIG. 13. The partition wall 26B partitions the discharge chamber 26 into a portion located on the first electrode unit 20 side and a portion located on the second electrode unit 22 side. Since the configuration of the other components is the same as that of the first exemplary embodiment, a description thereof is omitted accordingly.

Even when the partition wall 26B is provided inside the discharge chamber 26 as described above, the plasma generation source 14 has common components, such as the outside wall of the discharge chamber 26 and the coil 28, for supplying ions to both the first and second electrode units 20 and 22. This contributes to making the ion gun compact, as is also the case in the first exemplary embodiment.

Next, a description of the seventh exemplary embodiment of the present invention will be given.

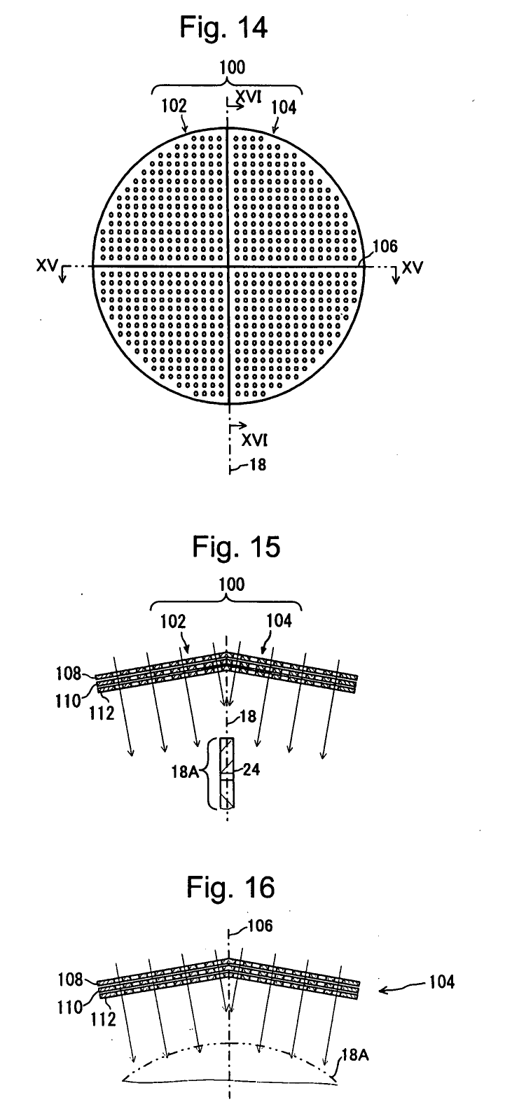

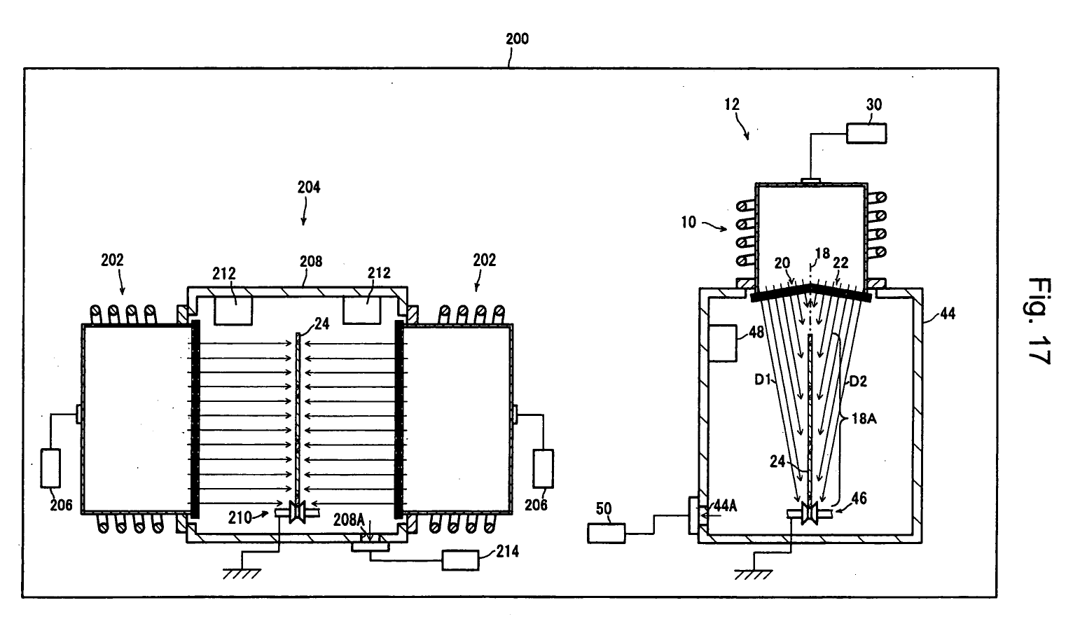

In contrast to the first exemplary embodiment, in the seventh exemplary embodiment, electrode plates 108, 110, and 112 constituting a first electrode unit 102 and a second electrode unit 104 of an extraction electrode unit 100 are configured as follows. In each of the electrode plates 108, 110, and 112, a portion of the electrode plate on one side of a plane 106 and a portion the electrode plate on the other side of the plane 106 are symmetrically inclined with respect to the plane 106 so as to face an intersecting portion of the plane 106 and the irradiation target area 18A, as shown in FIGS. 14 to 16. In this instance, the plane 106 passes through the center of the boundary between the first and second electrode units 102 and 104 and intersects the reference plane 18 at right angles so as to divide the irradiation target area 18A into two halves. Since the configuration of the other components is the same as that of the first exemplary embodiment, a description thereof is omitted accordingly.

It is important to note that, as in the first exemplary embodiment, each of the electrode plates 108, 110, and 112 is also symmetrically inclined with respect to the reference plane 18.

As described above, each of the electrode plates 108, 110, and 112 is symmetrically inclined with respect to the reference plane 18 and is also symmetrically inclined with respect to the plane 106 so as to face the intersecting portion of the plane 106 and the irradiation target area 18A. Also in this case, ions can be projected at a certain irradiation angle with respect to the reference plane 18. Moreover, the effect of increasing the intensity of ions projected onto the irradiation target area 18A can be obtained.

Next, a description of the eighth exemplary embodiment of the present invention will be given.

The eighth exemplary embodiment relates to an ion beam etching facility 200 shown in FIG. 17. The ion beam etching facility 200 includes: a perpendicular irradiation ion beam etching apparatus 204 provided with a perpendicular irradiation ion gun 202; and the (inclined irradiation) ion beam etching apparatus 12 of the first exemplary embodiment. The perpendicular irradiation ion gun 202 is capable of irradiating the surfaces of the plate-like workpieces 52 held by the irradiation object 24 with ions in a direction that is substantially perpendicular to the surfaces of the workpieces 52. The (inclined irradiation) ion beam etching apparatus 12 is capable of irradiating the surfaces of the workpieces 52 with ions in a direction that is inclined with respect to the surfaces of the workpieces 52.

The perpendicular irradiation ion beam etching apparatus 204 is provided with a pair of the perpendicular irradiation ion guns 202, and therefore the opposite surfaces of the workpieces 52 can be irradiated with ions. A gas supply apparatus 206 for supplying a processing gas, such as Ar, Xe, or Kr, for generating plasma is connected via a pipe to each of the perpendicular irradiation ion guns 202. In the perpendicular irradiation ion gun 202, the extraction electrode unit thereof has a planar structure. The structure of the other components of the perpendicular irradiation ion gun 202 is the same as that of the ion gun 10 of the first exemplary embodiment, and therefore a description thereof is omitted accordingly.

The perpendicular irradiation ion beam etching apparatus 204 is further provided with: a vacuum chamber 208; a supporting portion 210 for supporting the irradiation object 24; and a neutralizer 212. More specifically, the supporting portion 210 supports the irradiation object 24 between the pair of perpendicular irradiation ion guns 202 within the vacuum chamber 208 such that the opposite surfaces of the irradiation object 24 correspondingly face one of the pair of perpendicular irradiation ion guns 202. The supporting portion 210 may be configured so as to rotate the substantially disk-like irradiation object 24, as is the case for the supporting portion 46 of the (inclined irradiation) ion beam etching apparatus 12 in the first exemplary embodiment. Alternatively, the supporting portion 210 may be configured so as not to rotate the irradiation object 24 since the surface of the workpieces 52 is irradiated with ions from a direction that is perpendicular to the surfaces of the workpieces 52.

The vacuum chamber 208 has a substantially box-like shape and attachment portions for the pair of perpendicular irradiation ion guns 202 has opening. An exhaust hole 208A is provided in the lower portion of the vacuum chamber 208, and a vacuum pump 214 is connected to the exhaust hole 208A via a pipe.

Since the configuration of the (inclined irradiation) ion beam etching apparatus 12 has been described in the first exemplary embodiment, the redundant description is omitted accordingly. The configuration of the ion gun 10 of the (inclined irradiation) ion beam etching apparatus 12 may be similar to that detailed in the second to seventh exemplary embodiments.

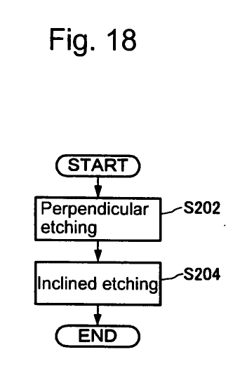

Next, the action of the ion beam etching facility 200 will be described with reference to the flowchart shown in FIG. 18 by taking, as an example, a method for manufacturing a magnetic recording medium that includes a step of flattening both sides of the workpieces 52 by etching both sides of the workpieces 52.

First, by means of the perpendicular irradiation ion beam etching apparatus 204, the opposite surfaces of the workpieces 52 held by the irradiation object 24 are irradiated with ions in directions that are substantially perpendicular to the opposite surfaces of the workpieces 52 (S202). The filling material 52C on the opposite surfaces of the workpieces 52 is removed as the ions impinge on the surfaces thereof. The ion irradiation is terminated before the upper surface of the convex portions of the recording layers 52B is exposed. By irradiating the surfaces of the workpieces 52 with ions in directions that are substantially perpendicular to the surfaces as described above, the etching rate for the filling material 52C can be improved, and this contributes to an improvement in production efficiency.

Next, by means of the (inclined irradiation) ion beam etching apparatus 12, the opposite surfaces of the workpieces 52 are irradiated with ions in directions that are inclined with respect to the opposite surfaces of the workpieces 52 (S204). When the upper surface of the convex portions of the recording layers 52B is exposed, the ion irradiation is terminated. In this manner, the surfaces of the workpieces 52 are flattened. By irradiating the opposite surfaces of the workpieces 52 with ions in directions inclined with respect to the surfaces, the tendency of convex portions to be selectively removed faster than concave portions is further enhanced. Therefore, high precision flattening can be performed. After the inclined etching step (S204) is complete, a protection layer and a lubrication layer are formed on both sides of the workpieces 52 in accordance with need, whereby the magnetic recording media are completed.

As described above, in the perpendicular etching step (S202), the filling material 52C is etched at a relatively high etching rate by means of the perpendicular irradiation ion beam etching apparatus 204. In the inclined etching step (S204), the filling material 52C is etched by means of the (inclined irradiation) ion beam etching apparatus 12 in which the tendency of convex portions to be selectively removed faster than concave portions is enhanced. By carrying out the perpendicular etching step (S202) and the inclined etching step (S204) in this order, both an improvement in production efficiency and high precision flattening can be compatible.

In the first to eighth exemplary embodiments, the first electrode unit 20 (74, 102) and the second electrode unit 22 (76, 104) are plane symmetric with respect to the reference plane 18. In addition, the irradiation angle formed by the first irradiation direction D1 and the reference plane 18 is the same as the irradiation angle formed by the second irradiation direction D2 and the reference plane 18. However, the irradiation angle formed by the first irradiation direction D1 and the reference plane 18 may be slightly different from the irradiation angle formed by the second irradiation direction D2 and the reference plane 18, so long as both sides of a workpiece can be flattened satisfactorily.

Furthermore, in the first to eighth exemplary embodiments, the extraction electrode unit 16 (72, 82, 100) is composed of the three electrode plates 34, 36, and 38 (84, 86, and, 88; 108, 110, and 112). However, the extraction electrode unit 16 (72, 82, 100) may be composed of two electrode plates or four or more electrode plates according to required specifications or the like.

Moreover, in the first to eighth exemplary embodiments, the electrode plates 34, 36, and 38 (84, 86, and, 88; 108, 110, and 112) have a flat surface shape. However, the electrode plates may have a curved surface shape, so long as both sides of a workpiece can be flattened satisfactorily.

Furthermore, in the first, second, and fourth to eighth exemplary embodiments, the extraction electrode unit 16 (82) has a substantially circular shape as viewed from the bottom. In the third exemplary embodiment, the extraction electrode unit 72 has a substantially rectangular shape as viewed from the bottom. However, the extraction electrode unit may have a shape, such as a hexagonal shape or an ellipsoidal shape, other than a circular shape and a rectangular shape, according the shape or the like of an irradiation object.

Furthermore, in the first to eighth exemplary embodiments, a plurality of the workpieces 52 held by the irradiation object 24 are etched simultaneously. However, the present invention is applicable to processing of a single workpiece.

Moreover, in the first to eighth exemplary embodiments, a noble gas such as Ar, Kr, or Xe is exemplified as the processing gas. However, both sides of the workpieces 52 may be flattened by using a gas containing a gas (an oxygen-containing gas or a halogen-containing gas) having a property of chemically reacting with the filling material 52C to make the filling material 52C brittle.

Furthermore, in the first to eighth exemplary embodiments, the plasma generation source 14 is of the inductive coupling type. However, there may be used, for example, a DC plasma source or a high frequency plasma source such as the ECR (electron cyclotron resonance) type, the helicon wave plasma type, the capacitive coupling type.

Moreover, in the eighth exemplary embodiment, the filling material 52C is first etched at a high etching rate by irradiating the opposite surfaces of the workpieces 52 with ions in respective directions perpendicular to the opposite surfaces of the workpieces 52 by means of the perpendicular irradiation ion beam etching apparatus 204 (S202). Subsequently, the opposite surfaces of the workpieces 52 are irradiated with ions in respective directions inclined with respect to the opposite surfaces of the workpieces 52 (S204). However, other etching apparatus such as a reactive ion etching apparatus may be used in place of the perpendicular irradiation ion beam etching apparatus 204. Also in this case, the filling material 52C can be etched at a high etching rate by using, for example, a gas containing a gas (an oxygen-containing gas or a halogen-containing gas) having a property of chemically reacting with the filling material 52C to make the filling material 52C brittle, and this contributes to the improvement of the production efficiency. In addition, etching may be performed in a reactive ion etching apparatus by using a noble gas, such as Ar, Kr, or Xe, as the processing gas.

Furthermore, in the first to eighth exemplary embodiments, discrete track media and patterned media are exemplified as the magnetic recording media obtained by processing the workpieces 52. However, the present invention is applicable to the manufacturing of magnetic disks having a spiral-shaped recording layer. Moreover, the present invention is applicable to the manufacturing of magneto-optical disks such as MO disks and heat assisted type recording disks in which both magnetism and heat are used.

1. An ion gun comprising:
a plasma generation source; and
an extraction electrode unit comprising a plurality of electrode plates each having a plurality of through holes formed therein to allow ions from the plasma generation source to pass therethrough, wherein
the extraction electrode unit comprises:
a first electrode unit including a portion of the plurality of electrode plates on a first side of a predetermined reference plane intersecting the electrode plates, with the portion being inclined with respect to the reference plane so as to face a predetermined irradiation target area which is provided along the reference plane on a farther side away from the plasma generation source than the extraction electrode unit; and
a second electrode unit including a portion of the plurality of electrode plates on a second side of the reference plane, with the portion being inclined with respect to the reference plane so as to face the irradiation target area.

2. An ion gun comprising:
a plasma generation source; and
an extraction electrode unit comprising a plurality of electrode plates each having a plurality of through holes formed therein to allow ions from the plasma generation source to pass therethrough, wherein
the extraction electrode unit comprises:
a first electrode unit including a portion of the plurality of electrode plates on a first side of a predetermined reference plane intersecting the electrode plates, the first electrode unit being provided for irradiating, from the first side, a predetermined irradiation target area with ions from the plasma generation source in an irradiation direction inclined with respect to the reference plane, the irradiation target area being provided along the reference plane on a farther side away from the plasma generation source than the extraction electrode unit; and
a second electrode unit including a portion of the plurality of electrode plates on a second side of the reference plane, the second electrode unit being provided for irradiating, from the second side, the irradiation target area with ions from the plasma generation source in an irradiation direction inclined with respect to the reference plane.

3. The ion gun according to claim 1, wherein the first electrode unit and the second electrode unit are plane symmetric with respect to the reference plane.

4. The ion gun according to claim 2, wherein the first electrode unit and the second electrode unit are plane symmetric with respect to the reference plane.

5. The ion gun according to claim 1, wherein the plasma generation source includes a common component for supplying ions to both the first electrode unit and the second electrode unit.

6. The ion gun according to claim 2, wherein the plasma generation source includes a common component for supplying ions to both the first electrode unit and the second electrode unit.

7. The ion gun according to claim 1, wherein, in each of the electrode plates, the portion included in the first electrode unit and the portion included in the second electrode unit are formed integrally.

8. The ion gun according to claim 2, wherein, in each of the electrode plates, the portion included in the first electrode unit and the portion included in the second electrode unit are formed integrally.

9. The ion gun according to claim 1, wherein a non-irradiating portion for preventing ion irradiation is provided between the first electrode unit and the second electrode unit.

10. The ion gun according to claim 2, wherein a non-irradiating portion for preventing ion irradiation is provided between the first electrode unit and the second electrode unit.

11. The ion gun according to claim 1, wherein, in each of the electrode plates, a portion on a side and another portion on another side of a plane passing through a center of a boundary between the first and second electrode units and intersecting the reference plane at right angles so as to divide the irradiation target area into two halves are inclined symmetrically with respect to the plane so as to face an intersecting portion of the plane and the irradiation target area.

12. The ion gun according to claim 2, wherein, in each of the electrode plates, a portion on a side and another portion on another side of a plane passing through a center of a boundary between the first and second electrode units and intersecting the reference plane at right angles so as to divide the irradiation target area into two halves are inclined symmetrically with respect to the plane so as to face an intersecting portion of the plane and the irradiation target area.

13. An ion beam etching apparatus, comprising the ion gun according to claim 1.

14. An ion beam etching apparatus, comprising the ion gun according to claim 2.

15. An ion beam etching facility, comprising:
a perpendicular irradiation ion beam etching apparatus comprising a perpendicular irradiation ion gun capable of irradiating a surface of a plate-like workpiece with ions in a direction substantially perpendicular to the surface of the workpiece; and an inclined irradiation ion beam etching apparatus comprising the ion gun according to claim 1.

16. The ion beam etching facility according to claim 15, wherein the perpendicular irradiation ion beam etching apparatus comprises a pair of the perpendicular irradiation ion guns and is capable of irradiating opposite surfaces of the workpiece with ions.

17. An etching method, comprising:
a workpiece placing step of placing a plate-like workpiece in the irradiation target area of the ion gun according to claim 1 so as to be parallel to the reference plane; and
an etching step of etching opposite surfaces of the workpiece by irradiating a surface of the workpiece with ions from the first electrode unit and irradiating another surface of the workpiece with ions from the second electrode unit.

18. A method for manufacturing a magnetic recording medium, comprising a step in which the etching method according to claim 17 is used.

19. The method according to claim 18, wherein the step using the etching method is a step of flattening the opposite surfaces of the workpiece.

20. A method for manufacturing a magnetic recording medium, using the ion beam etching facility of claim 15, comprising:
a perpendicular etching step of irradiating opposite surfaces of the workpiece with ions in respective directions substantially perpendicular to the respective opposite surfaces of the workpiece by means of the perpendicular irradiation ion beam etching apparatus; and
inclined etching step of irradiating the opposite surfaces of the workpiece in respective directions inclined with respective to the respective opposite surfaces of the workpiece by means of the inclined irradiation ion beam etching apparatus, wherein
the perpendicular etching step and the inclined etching step are carried out in this order.
